(19) United States
(12) Patent Application Publication
(10) Pub. No.: US 2009/0022348 A1
(43) Pub. Date: Jan. 22, 2009

(54) Hearing apparatus with a fastening facility for attaching an audio shoe and corresponding audio shoe

(75) Inventors: Holger Kral, Furth (DE); Michael Sattler, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL INSTRUMENTS PTE. LTD.

(21) Appl. No.: 12/218,488

(22) Filed: Jul. 15, 2008

(30) Foreign Application Priority Data
Jul. 19, 2007 (DE) 10 2007 033 714.2

(51) Int. Cl. H04R 25/00

(52) U.S. Cl. 381/324

(57) ABSTRACT

A hearing apparatus with a housing, which has a receiving surface for attaching an audio shoe is provided. The receiving surface has at least one first fastening facility, to which a corresponding second fastening facility of the audio shoe can be fastened such that the audio shoe can be attached to the hearing apparatus in a linear and essentially perpendicular fashion in respect of the receiving surface. An electrical and mechanical connection between the hearing apparatus and the audio shoe can thus be established in a simple fashion. According to a further aspect of the invention, a corresponding audio shoe is provided which can be attached to a hearing apparatus.

### CROSS REFERENCE TO RELATED APPLICATIONS

This application claims priority of German application No. 10 2007 033 714.2 DE filed Jul. 19, 2007, which is incorporated by reference herein in its entirety.

### FIELD OF INVENTION

The present invention relates to a hearing apparatus with a housing which has a receiving surface for attaching an audio shoe. The present invention also relates to a corresponding audio shoe, which can be attached to a hearing apparatus. The term hearing apparatus is understood here to mean a hearing device. The term also includes other wearable and non-wearable acoustic devices such as headsets, earphones and the like.

### BACKGROUND OF INVENTION

Hearing devices are wearable hearing apparatuses which are used to assist the hard-of hearing. In order to accommodate numerous individual requirements, various types of hearing devices are available such as behind-the-ear (BTE) hearing devices. hearing devices with an external receiver (RIC: receiver in the canal) and in-the-ear (ITE) hearing devices, for example also concha hearing devices or completely-in-the-canal (ITE, CIC) hearing devices. The hearing devices listed as examples are worn on the outer ear or in the auditory canal. Bone conduction hearing aids, implantable or vibrotactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter, e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted through a sound tube, which is affixed in the auditory canal by means of an otoplastic, to the device wearer's eardrum. Power for the hearing device and in particular for the signal processing unit 3 is supplied by means of a battery 5 which is also integrated in the hearing device housing 1.

A so-called audio shoe is used in many instances for hearing devices for recording external audio signals. The audio shoe is fastened to the hearing device so that the audio signals are transmitted from the audio shoe to the hearing device by means of electrical contacts. Different methods have been established to fasten an audio shoe to a housing of a hearing device. According to one of the methods originating from the applicant, the audio shoe is rotated onto the housing of the hearing device using a rotational movement.

The publication DE 10 2005 061 795 A1 discloses a hearing device module, which can be attached mechanically and electrically to a corresponding multi-purpose interface of a hearing device using an electromechanical interface. Here at least one hearing device operating element or display element is provided in the module. The module can also be inserted into a corresponding recess of the hearing device with two laterally protruding flanges and thus fastened to the hearing device.

### SUMMARY OF INVENTION

The object of the present invention consists in simplifying the receiving process of an audio shoe in a hearing apparatus.

This object is achieved in accordance with the invention by a hearing apparatus with a housing, which has a receiving surface for attaching an audio shoe, with the receiving surface having at least one first fastening facility, to which a corresponding second fastening facility of the audio shoe can be fastened such that the audio shoe can be attached to the hearing apparatus in a linear and essentially perpendicular fashion in respect of the receiving surface, in order to establish an electrical connection between the hearing apparatus and the audio shoe.

Furthermore, the object is achieved in accordance with the invention by an audio shoe, which can be attached to a hearing apparatus, with the hearing apparatus having a receiving surface for attaching the audio shoe, with a second fastening facility being provided, which can be fastened to a corresponding first fastening facility of the receiving surface of the hearing apparatus such that the audio shoe can be attached to the hearing apparatus in a linear and essentially perpendicular fashion in respect of the receiving surface, in order to establish an electrical connection between the hearing apparatus and the audio shoe.

The inventive hearing apparatus and audio shoe advantageously achieve in facilitating the attachment of the audio shoe to the hearing apparatus with a simple linear movement. This simple attachment process is hugely advantageous precisely for older people.

The first fastening facility preferably has two grooves, which are arranged in opposite border areas of the receiving surface of the hearing apparatus, and with the two grooves being designed so as to receive corresponding clips of the audio shoe. Accordingly, the second fastening facility preferably has two clips, which are arranged on opposite sides of the audio shoe essentially in parallel to one another and which are pretensioned by means of a helical spring, with it being possible to insert the two clips into corresponding grooves of the receiving surface of the hearing apparatus such that the two clips engage with the corresponding grooves and the helical spring effects a tensioning force between the two clips in order to stabilize the audio shoe on the hearing apparatus. An outstanding mechanical stability is advantageously achieved using the grooves arranged on the receiving surface of the hearing apparatus and the corresponding clips of the audio shoe. The helical spring and the tensioning force between the two clips of the audio shoe resulting therefrom also ensure that the audio shoe can be particularly easily removed from the hearing apparatus by a mutual pushing of the clips.

The receiving surface of the hearing apparatus preferably has an opening, which is assigned at least one electrical spring contact of the hearing apparatus, and which is designed so as to receive a corresponding flexibly mounted connecting plate of the audio shoe, in order to establish an electrical connection between the hearing apparatus and the audio shoe by means of the spring contact. Accordingly, with the audio shoe according to the invention, provision is made of a connecting plate including at least one conductor path, with it being possible to insert the connecting plate into a corresponding opening of the receiving surface of the hearing apparatus essentially perpendicular in respect of the receiving surface and with the corresponding opening being assigned at least one electrical spring contact, which is designed to establish an electrical connection between the audio shoe and the hearing apparatus by way of the conductor path of the connecting plate. A particularly reliable electrical connection is provided between the audio shoe and the hearing apparatus using the connecting plate and the conductor path arranged thereupon as well as using the corresponding opening in the receiving surface of the hearing apparatus. In particular, the spring contact arranged in the opening ensures that a greater tolerance range can be made available in respect of the angle of the attachment and removal movement of the audio shoe onto/away from the hearing apparatus. To this end, it is also favorable if the connecting plate is flexibly mounted in the audio shoe.

The audio shoe according to the invention preferably has at least one socket for connecting an external connecting element, with the helical spring also being designed to establish an electrical connection between the external connecting element and the at least one conductor path of the connecting plate. It is thus possible to use the helical spring not only for fastening purposes but also for establishing an electrical contact, thereby reducing the number of components of the audio shoe. Additional assembly, order and tool costs do not accumulate as a result.

### BRIEF DESCRIPTION OF THE DRAWINGS

The present invention is described in more detail with reference to the appended drawings, in which;

FIG. 1 shows a schematic design of a behind-the-ear hearing device;

FIG. 2 shows a schematic representation of a behind-the-ear hearing device with an audio shoe which can be attached thereto, from two different perspectives;

FIG. 3 shows a schematic representation of the behind-the-ear hearing device with the audio shoe attached thereto;

FIG. 4 shows the behind-the-ear hearing device including a receiving surface and the audio shoe which can be attached thereto;

FIG. 5 shows the behind-the-ear hearing device with the audio shoe attached thereto;

FIG. 6 shows a schematic design of the audio shoe; and

FIG. 7 shows a detailed exploded representation of the components of the audio shoe.

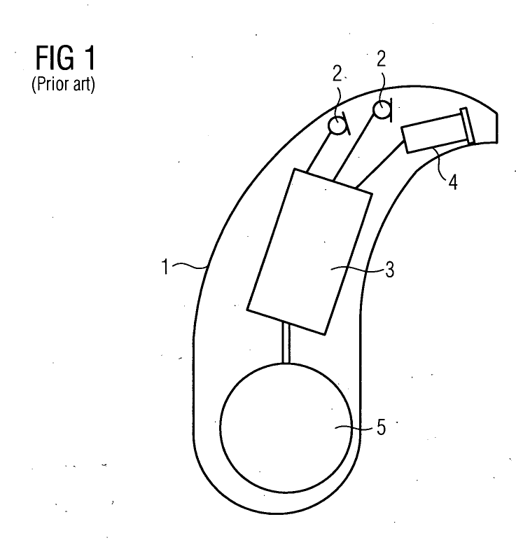

### DETAILED DESCRIPTION OF INVENTION

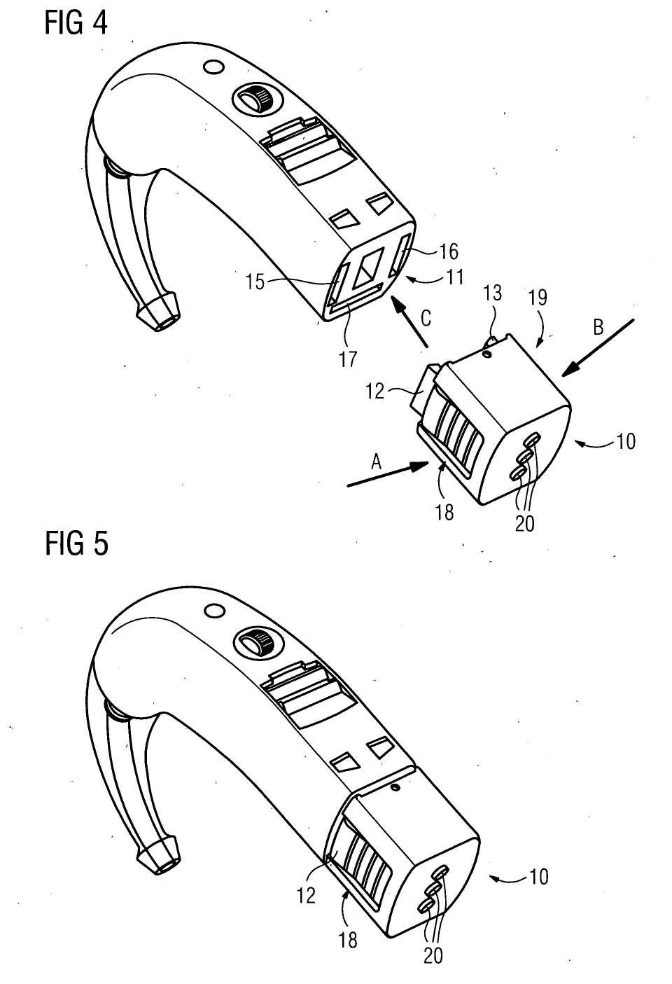

With a behind-the-ear hearing device shown from different perspectives in FIG. 2, an audio shoe 10 is used to record external audio signals. The audio shoe 10 can be attached to a front side 11 of the hearing device. To this end, the audio shoe 10 has two clips 12 and 13 arranged on opposite sides of the audio shoe 10, which can engage in corresponding grooves 15 and 16 (compare FIG. 4) of the hearing device. Furthermore, the audio shoe 10 is equipped with a connecting plate 14, by means of which an electrical connection between the audio shoe 10 and the hearing device can be established.

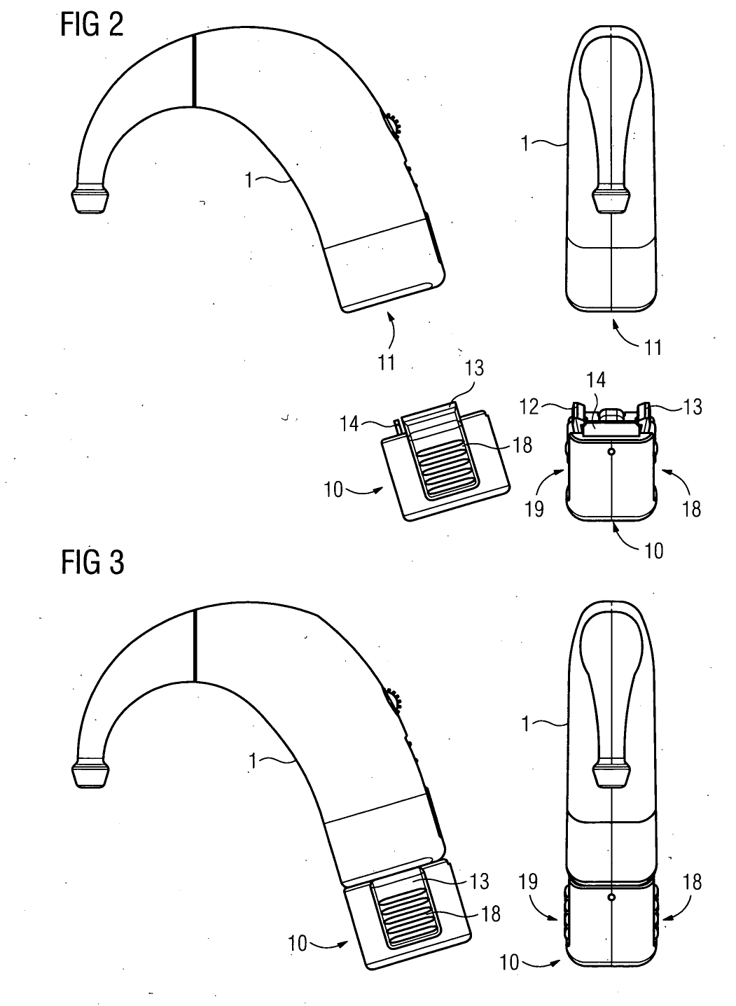

As shown in FIG. 3, the clips 12 and 13 of the audio shoe 10 allow the audio shoe 10 to be fastened to the front side 11 of the hearing device.

The grooves 15 and 16 corresponding to the clips 12, 13 are, as shown in FIG. 4, arranged in parallel to one another on opposite sides of the front side 11 of the hearing device. The front side 11 of the hearing device also has an opening 17, which is arranged in direct proximity to an edge of the front side 11 and in this instance perpendicular to the grooves 11 and 15. The connecting plate 14 of the audio shoe 10 can be accommodated in this opening 17 and the electrical connection between the audio shoe 10 and the hearing device can thus be established.

In order to receive the clips 12 and 13 of the audio shoe 10 in the corresponding grooves 15 and 16, the clips 12 and 13 are moveably mounted on the audio shoe 10 so that the clips 12 and 13 are opened by mutually pushing the audio shoe 10 on lateral surfaces 18 and 19 on both sides, thereby allowing the audio shoe 10 to be accommodated on the front side 11 of the hearing device. This process is shown in FIG. 4 on the basis of arrows A, B and C. The audio shoe 10 can be attached to the front side 11 of the hearing device even without the pushing movement because the clips 12 and 13 are moveably mounted and have a corresponding phase. The attached audio shoe 10, as shown in FIG. 5, can then be removed again from the hearing device by pushing on the side surfaces 18 and 19 of the audio shoe 10. As standard, the audio shoe 10 has three sockets 20 for connecting external connecting elements.

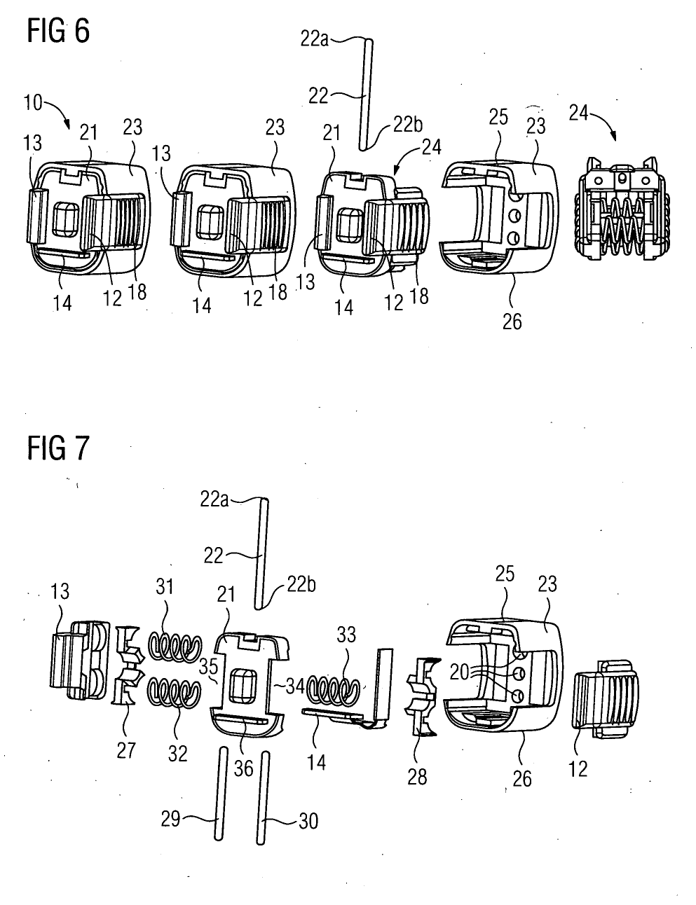

As apparent in FIG. 6, the audio shoe 10 consists essentially of two parts, a cover 23 and a connector mechanism 24, which is mounted in the cover 23 and is fastened by means of a fastening bolt 22. Here the fastening bolt 22 extends across the audio shoe 10 between two sides 25 and 26 of the cover 23 which lie opposite one another.

The connector mechanism 24 of the audio shoe 10 has a base plate 21, which also has a continuous opening, through which the fastening bolt 22 extends when in a fastened state. A stable fastening of the essential part 24 in the cover 23 is enabled as a result of the fastening bolt 22 resting its two ends 22a and 22b accordingly against the two sides 25 and 26 of the cover 23.

According to the exploded representation in FIG. 7, the connector mechanism 24 of the audio shoe 10 has three helical springs 31, 32 and 33, which effect a tensional force between the clips 12 and 13. The helical springs 31, 32 and 33 and the fact that the clips 12 and 13 are moveably mounted means that the clips 12 and 13 engage in the corresponding grooves 15 and 16 of the hearing device and a stable position of the audio shoe 10 on the hearing device is enabled by virtue of the thus achieved pretensioning. Furthermore, two further fastening bolts 29 and 30 are provided, which have the task of mounting the clips 12 and 13 to the base plate 21 in a pivotable fashion. To this end, the base plate 21 has two additional continuous openings, which extend along the base plate 21.

The base plate 21 also has two sections 34 and 35. The clips 12 and 13 are received essentially perpendicular in respect of the base plate 21 in these two sections 34 and 35. The clips 12 and 13 each have a corresponding recess for a fastening bolt 29, 30.

The connector mechanism 24 of the audio shoe 10 also includes two guide elements 27 and 28, which are designed to guide and/or stabilize the helical springs 31, 32 and 33 in respect of the clips 12 and 13.

The base plate 21 is also provided with a longish opening 36, the longitudinal direction of which runs perpendicular to the fastening bolts 22, 29, 30 and through which the connecting plate 14 protrudes out of the audio shoe 10. As already mentioned, the audio shoe 10 has three sockets 20, which allow the connection of external connectors. To enable the electrical connection between the external connectors and the hearing device, the connecting plate 14 has three corresponding conductor paths. To this end, the helical springs 31, 32, and 33 also have the object of connecting the external connectors to a corresponding conductor path of the connecting plate in each instance, by a connector pin being clipped between two coils of a helical spring. This dual function of the helical springs 31, 32 and 33 dispenses with the need for additional components for connecting the sockets 20 to the connecting plate 14. This also creates a space-saving design of the audio shoe.

1.-8. (canceled)

9. A hearing apparatus, comprising:
a housing having a receiving surface for attaching an audio shoe, the receiving surface having a first fastening facility, to which a corresponding second fastening facility of the audio shoe attaches the audio shoe to the hearing apparatus in a linear and essentially perpendicular fashion in respect of the receiving surface and in order to establish an electrical connection between the hearing apparatus and the audio shoe.

10. The hearing apparatus as claimed in claim 9, wherein the first fastening facility includes two grooves which are arranged in opposite border areas of the receiving surface of the hearing apparatus, and with the two grooves being designed to receive corresponding clips of the audio shoe.

11. The hearing apparatus as claimed in claim 9, the receiving surface includes an opening, which is assigned at least one electrical spring contact of the hearing apparatus and which is designed to receive a corresponding flexibly mounted connecting plate of the audio shoe in order to establish an electrical connection between the hearing apparatus and the audio shoe via the spring contact.

12. The hearing apparatus as claimed in claim 10, the receiving surface includes an opening, which is assigned at least one electrical spring contact of the hearing apparatus and which is designed to receive a corresponding flexibly mounted connecting plate of the audio shoe in order to establish an electrical connection between the hearing apparatus and the audio shoe via the spring contact.

13. An audio shoe for attaching to a hearing apparatus, with the hearing apparatus having a receiving surface for attaching the audio shoe, the receiving surface having a first fastening facility, the audio shoe comprising:
a second fastening facility, which can be fastened to the corresponding first fastening facility of the receiving surface of the hearing apparatus such that the audio shoe is attachable to the hearing apparatus in a linear and essentially perpendicular fashion in respect of the receiving surface in order to establish an electrical connection between the hearing apparatus and the audio shoe.

14. The audio shoe as claimed in claim 13,
wherein the second fastening facility includes two clips are arranged on opposite sides of the audio shoe essentially parallel in respect of one another and are pretensioned via a helical spring, and
wherein the two clips are formed to insert into corresponding grooves of the receiving surface of the hearing apparatus such that the two clips engage in the corresponding grooves and that the helical spring effects a tensioning force between the two clips in order to stabilize the audio shoe to the hearing apparatus.

15. The audio shoe as claimed in claim 14,
further comprises a flexibly mounted connecting plate,
wherein the flexibly mounted connecting plates includes a conductor path,
wherein the connecting plate is formed to insert into a corresponding opening of the receiving surface of the hearing apparatus essentially perpendicular in respect of the receiving surface and with the corresponding opening being assigned an electrical spring contact, and
wherein the connecting plate is designed to establish an electrical connection between the audio shoe and the hearing apparatus via the conductor path of the connecting plate.

16. The audio shoe as claimed in claim 15,
further comprises a socket for connecting an external connecting element, and
wherein the helical spring also being designed to establish an electrical connection between the external connecting element and the conductor path of the connecting plate.

17. The audio shoe as claimed in claim 13,
further comprises a flexibly mounted connecting plate,
wherein the flexibly mounted connecting plates includes a conductor path,
wherein the connecting plate is formed to insert into a corresponding opening of the receiving surface of the hearing apparatus essentially perpendicular in respect of the receiving surface and with the corresponding opening being assigned an electrical spring contact, and
wherein the connecting plate is designed to establish an electrical connection between the audio shoe and the hearing apparatus via the conductor path of the connecting plate.

18. The audio shoe as claimed in claim 17,
further comprises a socket for connecting an external connecting element, and
wherein the helical spring also being designed to establish an electrical connection between the external connecting element and the conductor path of the connecting plate.

19. A hearing apparatus, comprising:
an audio shoe having a second fastening facility; and
a housing having a receiving surface for attaching the audio shoe,
wherein the receiving surface of the housing includes a first fastening facility,
wherein the audio shoe includes a corresponding second fastening facility,
wherein the audio shoe is attached to the housing via the fastening facilities in a linear and essentially perpendicular fashion in respect of the receiving surface, and
wherein an electrical connection between the hearing apparatus and the audio shoe is established via the attachment of the audio shoe to the housing.

20. The hearing apparatus as claimed in claim 19,
wherein the second fastening facility includes two clips are arranged on opposite sides of the audio shoe essentially parallel in respect of one another and are pretensioned via a helical spring,
wherein the first fastening facility include corresponding groves, and
wherein the audio shoe is attached to the housing by inserting the clips into the corresponding groves such that the two clips engage in the corresponding grooves and that the helical spring effects a tensioning force between the two clips in order to stabilize the audio shoe to the hearing apparatus.

21. The hearing apparatus as claimed in claim 19,
wherein the audio shoe comprises a flexibly mounted connecting plate,
wherein the flexibly mounted connecting plates includes a conductor path,
wherein the connecting plate is inserted into a corresponding opening of the receiving surface of the hearing apparatus essentially perpendicular in respect of the receiving surface and with the corresponding opening being assigned an electrical spring contact, and
wherein the connecting plate establishes an electrical connection between the audio shoe and the hearing apparatus via the conductor path of the connecting plate.
